(19) United States
(12) Patent Application Publication
(10) Pub. No.: US 2017/0374722 A1
(43) Pub. Date: Dec. 28, 2017

(54) Lighting Fixture Controlling Device, Light Controlling System and Method for Controlling Energy Consumption

(71) Applicant: Lightfox Ltd., Shatin (HK)

(72) Inventors: Dirk Beiner, Paderborn (DE); Wilson Chim, Hong Kong (HK)

(21) Appl. No.: 15/190,004

(22) Filed: Jun. 22, 2016

(51) Int. Cl. H05B 37/02

(52) U.S. Cl. CPC H05B 37/0227; H05B 37/0218; H05B 37/0272

(57) ABSTRACT

A lighting fixture controlling device includes a power input connectable to a power supply, a power output for connecting the device with a lighting fixture, an electricity metering device that is configured to determine an amount of electric energy conducted to the lighting fixture, a motion detector that includes a microwave sensor, and an output controller that is configured to control the electric energy output by the power output based on motion data provided by the motion detector and based on the determined amount of electric energy.

### TECHNICAL FIELD

Embodiments of the present invention relate to a lighting fixture controlling device, a light controlling system, the method for controlling energy consumption.

### BACKGROUND

In conventional lighting systems the energy consumption of the light sources and the lighting fixtures respectively is controlled by light switches that are installed on walls. More sophisticated lighting control products have been aiming to provide more comfort to the users and to reduce energy consumption by usage optimization. Those solutions comprise different approaches and several separate devices.

### SUMMARY

Embodiments of the present invention relate to a lighting fixture controlling device. In particular embodiments, the present invention relates to a device, which is capable of controlling the energy consumption of the lighting fixture based on data of a microwave motion detector. Embodiments of the invention further relates to a light controlling system that comprises a multitude of lighting fixture controlling devices. Further embodiments of the invention relate to a method for controlling energy consumption of a light source. In particular embodiments, the present invention relates to a method for controlling the energy consumption based on measured motion.

According to one aspect of the invention, a lighting fixture controlling device is provided. The device comprises a power input connectable to a power supply, a power output for connecting the device with a lighting fixture, an electricity metering device, the electricity metering device being configured to determine an amount of electric energy conducted to the lighting fixture, a motion detector, the motion detector comprising a microwave sensor, an output controller, the output controller being configured to control the electric energy output by the power output based on motion data provided by the motion detector and based on the determined amount of electric energy.

According to a second aspect, a light controlling system comprises a multitude of light controlling devices according to the first aspect. Each light controlling device of the multitude of light controlling devices is configured to communicate with the other light controlling devices of the multitude of light controlling devices. The system further comprises a cloud-based service. The light controlling system is configured to provide the determined amount of electric energy of the multitude of light controlling devices and the data provided by the motion detector to the cloud-based service. The light controlling system is configured to receive control data, the control data comprising control information for controlling the electric energy output. Any kind of sensor information may be pushed into the cloud-based service.

According to a third aspect, a method for controlling energy consumption of a light source is provided. The method comprises the steps of: measuring a motion within a predefined area with a microwave motion sensor, determining electric energy consumption of the light source, modifying a light output of the light source according to the measured motion and the determined electric energy consumption.

The described devices, systems and methods enable a single control box for power metering, energy consumption controlling and light controlling. Hence, it is easy to install and operate the devices and systems. Multiple elements are combined in a single unit. The devices, systems and methods are compatible with different kinds of lighting fixture and light source respectively. The lighting fixture needs to be compatible with at least one of the controlling functions of the devices, systems and methods. It is easy to reduce the power consumption to a target level. With the devices, systems and methods it is for example possible to optimize the energy consumption in relation to ambience conditions detected by one sensor or more sensors. The controlling is based on sensor inputs from the motion detector and an ambient light sensor in particular. The controlling is for example based on a combination of the motion detector data and the ambient light sensor data. The devices, systems and methods are configured to factor in the motion sensor and the ambient light sensor as sensor inputs to modify the energy output and thereby the energy consumption. For example, a light output of the light source is primarily set on a defined light output level which is optimized according to the information of the sensors. Thereby, the devices, systems and methods are convenient and user friendly.

For example, controlling the electrical energy output includes at least one of sending a signal to the lighting fixture that changes the load, performing a switching and performing a dimming function.

According to another embodiment, a cloud based system comprises a processor and a non-transitory computer-readable storage medium storing a program to be executed by the processor. The program including instructions for: receiving information from a lighting control system at a remote location, the received information related to motion and energy consumption of a plurality of lighting units at the remote location; determining control information from the information related to the motion and the energy consumption of the lighting units; and transmitting the control information to the lighting control system so that the lighting control system can control an electric energy output of the lighting units.

For example, the lighting control system can comprise a plurality of lighting control devices, which are each configured to communicate with other light controlling devices via a respective wireless communication interface. The information received from the lighting control system comprises information determined by each of the lighting control devices.

### BRIEF DESCRIPTION OF THE DRAWINGS

Various embodiments of the present invention will be described with reference to the attached drawings. In the drawings, like reference symbols are used for like elements of different embodiments.

FIG. 1 shows a schematic implementation of a lighting fixture controlling device in accordance with an embodiment of the invention;

FIG. 2 shows a schematic diagram of a lighting fixture controlling device in accordance with an embodiment of the invention;

FIG. 3 shows a schematic diagram of a light controlling system in accordance with an embodiment of the invention; and

FIG. 4 shows a flowchart of an operation method for controlling energy consumption of a light source in accordance with an embodiment of the invention.

### DETAILED DESCRIPTION OF ILLUSTRATIVE EMBODIMENTS

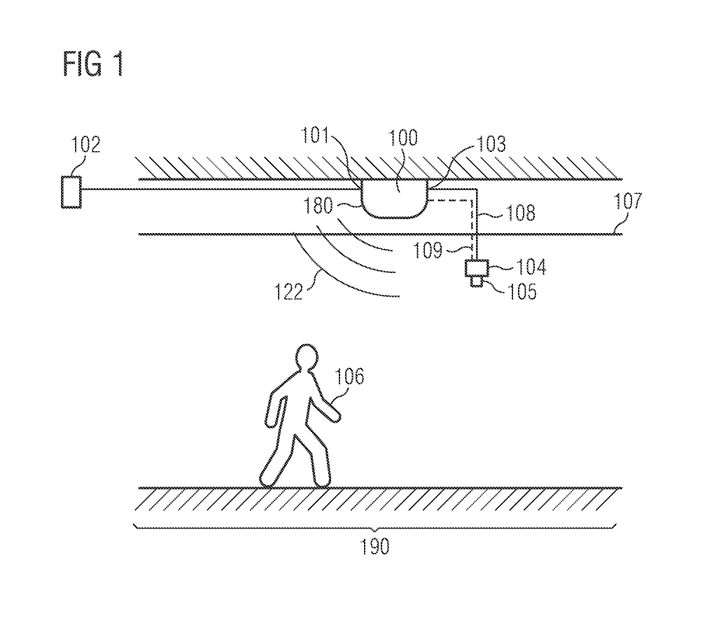

FIG. 1 shows a schematic implementation of a light controlling device 100.

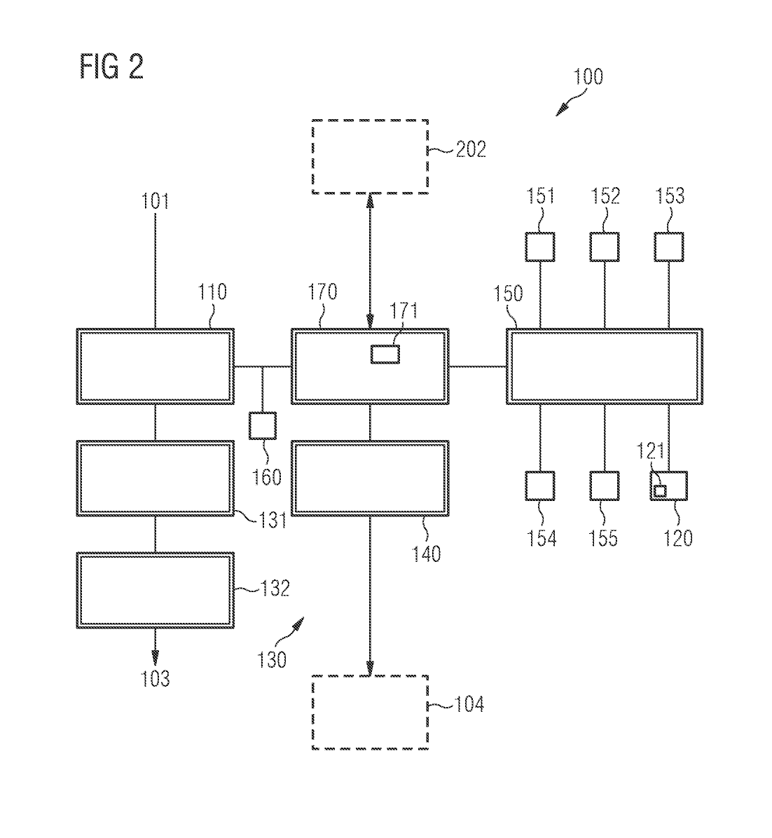

The light controlling device 100 is designed as schematically shown in FIG. 2, for example.

The light controlling device 100 is realized as a single electronic unit with a power input 101. The power input 101 is connected to a power supply 102. The power supply 102 may be a supply line that connects a site or a room where the device 100 is installed to an energy supplier. The site may be residential, e.g., an apartment or a house, or commercial, e.g., an office building, a factory or a warehouse. Electric energy of the power supply 102 is conducted to the light controlling device 100 via the power input 101.

The light controlling device 100 comprises a power output 103. The light controlling device 100 is connected to a lighting fixture 104 via the power output 103. Electric energy of the power supply 102 is conducted to the lighting fixture 104 via the light controlling device 100. A light source 105 is installed in the lighting fixture 104. The light source 105 may be any kind of electric lamp that produces visible light. The light source 105 is a light bulb and/or comprises LEDs, for example.

The light controlling device 100 is configured to modify a light output of the lighting fixture 104 and the light source 105, respectively. In particular, the light controlling device 100 is compatible with existing lighting fixture 104. Hence, the light controlling device 100 may be integrated into an existing lighting system of the site. The light controlling device 100 follows a retrofittable approach and thus is compatible with a multitude of different kinds of lighting fixture 104 being connected to the power supply 102.

A power connection 108, for example a power line, connects the lighting fixture 104 with the light controlling device 100. A further control connection 109 is optional. The control connection 109 is, for example, a bus control system. For example, the lighting fixture 104 comprises a data bus for receiving a control signal from the light controlling device 100 via the control connection 109. The control connection 109 may be a wireless connection or a cable connection.

As shown in more detail in FIG. 2, the light controlling device 100 comprises a motion detector 120. The motion detector 120 comprises a microwave sensor 121. For example, the microwave sensor 121 has a detection range of 3 to 20 meters (wall mounting). Other detection ranges are possible as well. In addition, the motion detector 120 may comprise a passive infrared motion sensor or another sensor, which is capable of determine a motion. The motion detector 120 is configured to measure motion of an object in its area 190 of view. For example, the object is a person 106 that moves in the field of view of the light controlling device 100 with the motion detector 120.

The motion detector 120 emits and receives microwaves 122. The microwaves 122 emitted by the motion detector 120 are reflected by the person 106. When the person 106 moves through the microwaves 122 relative to the generating source, which is the microwave sensor 121, a change in frequency of the reflected microwaves received by the motion detector 120 is detectable. When the person 106 moves away from the light controlling device 100 the wavelength of the reflected microwaves increases. When the person 106 approaches the light controlling device 100, the wavelength of the reflected microwaves decreases. The change in frequency and wavelength respectively is used to detect a motion of the person 106 in the area 190. Hence, the light controlling device 100 with the motion detector 120 uses the Doppler shift to detect a motion in the field of view of the light controlling device 100.

As the microwaves 122 can pass through objects, the light controlling device 100 may be installed behind a ceiling 107. Due the use of a microwave sensor 121 in the motion detector 120 the light controlling device 100 can be installed such that it is not visible for the person 106. The light controlling device 100 may be installed in a wall or behind any covering that is at least partly transparent for the microwaves 122 but not transparent for visible light.

The light controlling device 100 further comprises an electricity metering device 110. The electricity metering device 110 allows for measuring the energy consumption of the lighting fixture 104 and the light source 105, respectively, which are connected to the light controlling device 100. According to further embodiments, more than one lighting fixture 104 is connected to the power output 103 of the light controlling device 100. For example, all lighting fixtures 104 in a room are connected to a single light controlling device 100 assigned to that room. The electricity metering device 110 determines an amount of electric energy conducted to the lighting fixture 104.

The light controlling device 100 further comprises an output controller 130. The output of the output controller may be a dimming via the power line 108 or a control output signal via the control connection 109.

In one embodiment, the output controller 130 only consists of a switch 132. In that embodiment the light controlling device 100 modifies the electric energy consumption of the lighting fixture 104 by switching the switch 132 and thus turning the electricity to the lighting fixture 104 on an off.

For example, when a motion of the person 106 in the area 190 is detected by the motion detector 120 the output controller 130 switches the switch 132 such that the light source 105 is turned on and visible light is emitted by the light source 105. Electric energy which is consumed thereby is determined by the electricity metering device 110. When a motion of the person 106 is no longer detected, the light source 105 is turned off by the output controller 130, for example after a given delay. For example, the delay is given dependent on a given threshold for electrical energy consumption. For example, the threshold is a maximum amount of electrical energy that the light fixture 104 is allowed to consume in a given period, for example a day, a week or a month. When the amount of electrical energy determined by the electricity metering device no is close to the threshold or exceeds the threshold, the delay may be shortened or even be zero.

According to further embodiments the output controller 130 additionally comprises a dimmer 131. The dimmer 131 is configured to adjust the brightness of the light source 105. In particular, the dimmer 131 is used to lower the brightness of the light source 105 and hence lower the electrical energy consumption. For example, when the energy consumption determined by the electricity metering device no is closer to the threshold or exceeds the threshold in the given period, the dimmer 131 lowers the brightness of the light emitted by the light source 105 to reduce the electric energy consumption. On the other hand, if it is detected that the light intensity in a specific room that is monitored by the controlling device 100 is below a given threshold, the dimmer 131 is uses to increase the brightness of the light source 105 to reach the threshold for the light intensity in the room.

According to further embodiments, the output controller 130 comprises a light controller 14o. The light controller 140 may be additional to the dimmer 131 and/or the switch 132 or may be provided instead of the dimmer 131 and the switch 132. The light controller 140 is configured to generate a control signal for the light fixture 104. The control signal, for example, comprises information to turn on or off the light source 105 or to adjust the brightness of the light emitted by the light source 105. Hence, it is possible to control the electric energy consumed by the lighting fixture 104 via the light controller 140. The light controller 140 is connected with the lighting fixture 104 via the control connection 109. The light controller 140 can be used when the light controlling device 100 is connected with a type of lighting fixture 104 that is controllable by the control signal. A light controller 140 controls the lighting fixture 104 when a bus control system is available.

The light controlling device 100 with the electricity metering device no, the motion detector 120 and the output controller 130 adds a sensor interaction to the lighting fixture 104 for interaction with the environment as well as a power metering functionality.

According to an embodiment, the motion detector 120 is part of a sensor device iso. In addition to the motion detector 120, the sensor device 150 further comprises at least one of an ambient light sensor 151, a temperature sensor 152, a humidity sensor 153, a smoke sensor 154 and a gas sensor 155.

The sensors 151 to 155 of the sensor device 150 are configured to provide information about ambient conditions in the area 19o. The output controller 130 is configured to control the electric energy output conducted to the lighting fixture 104 based on the data provided by the sensor device. The output controller 130 or the light controller respectively are configured to control the energy output and the energy consumption respectively based on inputs from or more values received from one or more of the sensors 151 to 155. For example, the brightness of the light source 105 is adjusted dependent on the intensity of the ambient light, especially natural daylight or light of other light sources than the light source 105. The brightness of the light source 105 is lowered to a minimum level such that a given brightness in the area 190 is detected by the ambient light sensor 151. Hence, the electrical energy consumed by the lighting fixture 104 can be reduced by including the brightness of other light sources. With the aid of the ambient light sensor 151 a minimum ambient brightness in the area 190 is realized and the electrical energy consumed by the light source 105 is reduced as much as possible. The data of the other sensors of the sensor device 150 may be used correspondingly.

For example, the gas sensor 155 can be utilized for emergency alarm and full brightness level independent of other sensor data. The humidity sensor 153 can be utilized to shift sensor data to the cloud-base service and allow control of lighting fixtures on conditional events in industrial or medical environments such as laboratories. Temperature, humidity and gas sensors do not primarily contribute to energy saving but the system allows certain warning if the parameters of the sensors exceed certain thresholds, and reflect in the lighting behavior, for example a constant dim up/down to alert the users.

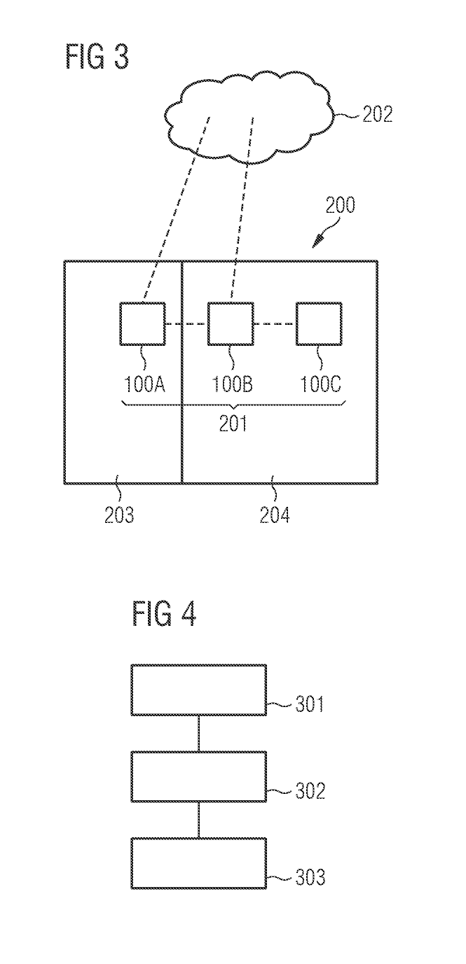

According to one embodiment, the output controller 130 is configured to compare the data provided by the sensor device 150 with pre-set ambient conditions. For example, the preset ambient conditions are stored in a memory 160 of the light controlling device 100. According to further embodiments, the pre-set ambient conditions are stored in a storage of a cloud-based service 202 (FIG. 3). The electric energy conducted to the lighting fixture 104 via the power connection 108 is controlled by the light controlling device 100 dependent on the comparison of the determined ambient conditions and the pre-set ambient conditions as well as motion detected by the motion detector 120. For example, the given minimum ambient brightness for the area 190 is dependent on the time of day. In an office, during working hours the minimum ambient brightness is higher than at night. When a motion in the area 190 is detected outside business hours, for example due to a security officer coming into the area 190, the light controlling device 100 controls the lighting fixture 104 such that the light source 105 only emits light with a low brightness to conserve and reduce power.

The electricity metering device no comprises a communication interface 170. The communication interface 170 is configured to provide a communication interface with a further light controlling device as shown in FIG. 3. Additionally or alternatively the communication interface 170 provides a communication interface with the cloud-based service 202.

According to embodiments, the communication interface 170 comprises a wireless transmission system 171. For example, the wireless transmission system 171 is configured to exchange data based on the IEEE 802.15.4 standard. Hence, the light controlling device 100 can communicate wirelessly with other devices 100 to operate in groups. Further, it is possible to trigger the light controlling device 100 remotely. The information determined by the sensor device 150 and/or the electricity metering device no can be communicated within the network to allow a gateway unit to upstream the information into a cloud server of the cloud-based service 202.

A remote trigger for power conservation and reduction can be applied via the communication interface 170. Hence, the electric energy conducted to the lighting fixture 104 can be controlled dependent on presets that are defined in the cloud-based service 202 to control the electrical energy consumption of the lighting fixture 104 based on a motion detected by the motion detector 120 in the related area 190. Information collection as well as control orchestration over groups is enabled via the communication interface 170. Remote triggers for configuration and power consumption reduction to a target level can be received with a feedback channel for performance tracking.

The light controlling device 100 according to the present application combines at least the electricity metering device 110, the motion detector 120 and the output controller 130 in a single electronic unit. The light controlling device 100 is integrated in a single electronic unit within a single housing 180.

FIG. 3 shows a light controlling system 200 that comprises a multitude 201 of light controlling devices 100A, 100B and 100C. According to further embodiments, the multitude 201 of light controlling devices comprises more than three light controlling devices 100, for example four or more devices 100. Of course, the multitude 201 of light controlling devices may comprise two light controlling devices 100. The light controlling devices 100A, 100B and 100C of the multitude 201 of the light controlling devices are configured as explained with respect to the light controlling device 100.

The light controlling devices 100A and 100B are connected via their respective communication interface 170. The light controlling devices 100B and 100C are connected via their respective communication interface 170. The light controlling devices 100A and 100C are connected via the light controlling device 100B. Hence, the light controlling devices 100 of the multitude 201 of the light controlling devices may be connected to each other directly or indirectly.

The light controlling devices 100A and 100B are connected to the cloud-based service 202 via their respective communication interface 170. The light controlling device 100C is connected to the cloud-based service 202 via the light controlling device 100B. Hence, the light controlling devices 100 of the light controlling system 200 can be connected to the cloud-based service 202 directly or indirectly.

For example, the light controlling device 100A is arranged to detect a motion in a first room 203 and to determine the amount of electrical energy consumed by the lighting fixtures 104 in the first room 203. The light controlling devices 100B and 100C are arranged in a second room 204 to detect a motion in the second room 204 and to determine an amount of electrical energy consumed by the lighting fixtures 104 in the second room 204. According to further embodiments, the location of the light controlling devices 100 in the rooms may be different and more or less rooms may be monitored by the light controlling system 200.

In one embodiment, the cloud based system comprises a processor 205 and a non-transitory computer-readable storage medium 206 that stores a program to be executed by the processor 205. The program including instructions for: receiving information from a lighting control system 201 at a remote location. The received information is related to motion and energy consumption of a plurality of lighting units 104 at the remote location; determining control information from the information related to the motion and the energy consumption of the lighting units 104; and transmitting the control information to the lighting control system 201 so that the lighting control system 201 can control an electric energy output of the lighting units 104.

In this example, the lighting control system comprises the multitude 201 of the light controlling devices. Each light controlling device is configured to communicate with other light controlling devices via a respective wireless communication interface. The information received from the lighting control system comprises information determined by the multitude 201 of the light controlling devices.

FIG. 4 shows steps performed for controlling energy consumption of a light source, for example the light source 105. The steps 301 to 303 may be performed by the light controlling device 100.

In a first step 301, a motion within the predefined area 190 is measured, for example by the microwave motion sensor 121.

In step 302 an electric energy consumption of the light source 105 is determined. For example, the electric energy consumption is determined by the electricity metering device 110.

In step 303 the light output of the light source 105 is modified according to the measured motion and the determined electric energy consumption. For example, the light output of the light source 105 is modified to reduce the electric energy consumption as much as possible but still provide a sufficient light output when a motion is detected.

According to further embodiments, defined settings for modifying the light output are received. The light output of the light source is modified according to the received settings. For example, the settings comprise given minimum values for an ambient brightness in the predefined area 190.

The light controlling device 100 is a combined unit that integrates a power metering functionality and a control functionality for the lighting fixture 104 in a single unit. The light controlling device 100 is able to be inserted between a power line that feeds the lighting fixture 104. The light controlling device 100 is inserted between the power supply 102 and the lighting fixture 104. The operation of the lighting fixture 104 is monitored with the electricity metering device no. As the light controlling device 100 is mounted in the electric circuit, the switch 132, a relay switching unit, for example, and the optional dimmer 131, a DC or AC dimming unit for example, can cut power or provide a dimming functionality over the power supply wire 108.

In addition, the light controlling device 100 is able to generate a control signal with the light controller 140. The control signal may be a 0-10V, PWM or DALI standard to deliver the dimming control signal to lighting fixtures 104 which are control enabled. Further protocol enhancements can be foreseen.

The sensor device 150 with the motion detector 120 based on the microwave Doppler effect, temperature sensor 152, humidity sensor 153, ambient light sensor 151, smoke sensor 154, gas sensor 155 and/or a fire sensor delivers information with regard to the ambient environment conditions in the area 190.

The communication interface 170 with the wireless transmission system 171 is able to communicate to other light controlling devices 100 (mesh network) via ZigBee or similar wireless communication protocols. The communication interface 170 is a data interface that is able to receive configuration and setting information as well as to report the current status of the sensors and the power consumption. In addition, a manual trigger signal can be received from the network to lower down the energy consumption in the saturation of given lower limits to further decrease the power consumption. Conditions for this can be target settings for a minimum power consumption and a maintenance of certain light levels to lower the power consumption with respect to parental system guidelines. The receiving and emitting transceiver can be either a second node inside the system or a gateway to a parental system (host controller or cloud solution). The mesh of the system 200 is able to update configuration information for the light controlling device 100 via wireless communication up to the extent of exchanging the complete firmware.

The sensor device 150 can be enhanced with various further sensors. The further sensors can be internally or externally attached directly to the light controlling device 100 or be connected to the light controlling device 100 via the communication interface 170. Multiple data bus protocols may be added physically and/or as software. The light controlling device 100 may be equipped with a USB port for the purpose of manual configuration. A wireless keypad may deliver manual override functionality to temporarily or permanently change settings and automatic functionalities.

The light controlling device 100 provides an automated control of the lighting fixture 104 to reduce electrical energy consumption and make adjustments based on conditions such as occupancy or daylight availability. The light controlling device 100 can control the light output of the light source 105 based on given presets to achieve some aesthetic or practical effects and thereby considers the energy consumption determined by the electricity metering device no and the presence of motion in the scanned area 190.

1. A lighting fixture controlling device comprising:
a power input connectable to a power supply;
a power output for connecting the device with a lighting fixture;
an electricity metering device, which is configured to determine an amount of electric energy output by the power output to the lighting fixture;
a sensor device that includes a further sensor that is one of a temperature sensor, a humidity sensor, a smoke sensor or a gas sensor;
a motion detector that is part of the sensor device and that comprises a microwave sensor;
an ambient light sensor; and
an output controller, which is configured to control the electric energy output by the power output based on motion data provided by the motion detector and based on the determined amount of electric energy,
wherein all elements of the light fixture controlling device are arranged in a single unit that integrates power meter functionality and control functionality,
wherein the output controller is configured to compare data provided by the ambient light sensor with pre-set ambient conditions,
wherein the electric energy provided to the lighting fixture via a power connection is controlled by the light controlling device dependent on a comparison of determined ambient conditions detected by the ambient light sensor and the pre-set ambient conditions as well as motion detected by the motion detector;
wherein the output controller is configured to control the electric energy output by the output controller according to sensor device data provided by the sensor device; and
wherein the output controller is configured to provide an emergency alarm and to change a brightness level of the lighting fixture by controlling the electric energy output by the power output, wherein the output controller is configured to provide the emergency alarm and to change the brightness level according to further sensor data generated by the further sensor exceeding a predetermined threshold and independently of data generated by a sensor other than the further sensor.

2. The device according to claim 1, wherein the output controller comprises a light controller, the light controller being configured to generate a control signal for the light fixture to control the electric energy output.

3. (canceled)

4. The device according to claim 1, wherein the output controller is configured to compare the data provided by the sensor device with preset ambient conditions and to control the electric energy output by the power output based on the comparison.

5. The device according to claim 1, wherein the output controller is configured to compare the determined amount of electric energy with a threshold and to reduce the electric energy output, when the determined amount of electric energy exceeds the threshold.

6. (canceled)

7. The device according to claim 1, comprising a communication interface to communicate with a further light controlling device and/or a cloud-based service.

8. The device according to claim 7, wherein the communication interface comprises a wireless transmission system.

9. A light controlling system comprising:
a plurality of lighting fixture controlling devices according to claim 7, wherein each light controlling device is configured to communicate with the other light controlling devices via a respective communication interface,
a cloud-based service, wherein the light controlling system is configured to provide the determined amount of electric energy of the plurality of light controlling devices and the data provided by the motion detector to the cloud-based service and the light controlling system is configured to receive control data, the control data comprising control information for controlling the electric energy output.

10. The system according to claim 9, wherein the light controlling system is configured to being controlled directly by the cloud-based service.

11. A method for controlling energy consumption of a light source, the method comprising:
measuring, by a microwave motion sensor that is part of a sensor device, a motion within a predefined area;
determining, by an electric metering device, an electric energy consumption of the light source;
measuring, by an ambient light sensor, ambient conditions;
comparing, by an output controller, the ambient conditions with pre-set ambient conditions;
modifying a light output of the light source according to the measured motion, the compared ambient conditions and the determined electric energy consumption,
controlling the electric energy output by the output controller according to sensor device data provided by the sensor device;
monitoring, by a further sensor in the sensor device, a further sensed condition, wherein the further sensor is one of a temperature sensor, a humidity sensor, a smoke sensor or a gas sensor; and
providing an emergency alarm and changing a brightness level of the lighting fixture by controlling the electric energy output by the power output, wherein emergency alarm is provided, and the brightness level is changed, according to further sensor data generated by the further sensor data exceeding a predetermined threshold and independently of data generated by a sensor other than the further sensor, wherein the further sensor data is associated with the further sensed condition;
wherein the microwave motion sensor, the electric metering device, the output controller and the ambient light sensor are arranged in a single light fixture controlling device that integrates power meter functionality and control functionality.

12. The method according to claim 11, further comprising receiving defined settings for modifying the light output, wherein modifying the light output comprises modifying the light output of the light source according to the received settings.

13. The method according to claim 11, further comprising comparing the determined electric energy consumption with a threshold, wherein modifying the light output comprises reducing the light output when the determined electric energy consumption exceeds the threshold.

14-17. (canceled)

18. The device according to claim 1, wherein the output controller is configured to control the brightness of the lighting fixture according to the further sensor data independently of data generated by the electricity metering device, the motion detector, and the ambient light sensor.

19. The device according to claim 1, wherein the further sensor is the gas sensor.

20. The device according to claim 1, wherein the further sensor is the humidity sensor, and wherein the output controller is configured to provide the emergency alarm and to change the brightness level of the lighting fixture according to humidity data generated by humidity sensor exceeding the predetermined threshold.

21. The device according to claim 1, wherein the further sensor is one of the temperature sensor, the humidity sensor, or the gas sensor, and wherein the output controller is configured to provide the emergency alarm and to change the brightness level independently of a regard for energy saving, according to the further sensor data exceeding one or more thresholds, and by causing a constant dim up or down of the brightness level of the lighting fixture to alert a user of an emergency condition.

22. The method according to claim 11, wherein the providing the emergency alarm and the changing the brightness level include controlling the brightness of the lighting fixture according to the further sensor data independently of data generated by the electricity metering device, the motion sensor, and the ambient light sensor.

23. The method according to claim 11, wherein the further sensor is the gas sensor.

24. The method according to claim 11, wherein the further sensor is the humidity sensor, and wherein the providing the emergency alarm and the changing the brightness level include providing the emergency alarm and changing the brightness level of the lighting fixture according to humidity data generated by humidity sensor exceeding the predetermined threshold.

25. The method according to claim 11, wherein the further sensor is one of the temperature sensor, the humidity sensor, or the gas sensor, and wherein the providing the emergency alarm and the changing the brightness level include providing the emergency alarm and changing the brightness level independently of a regard for energy saving, according to the further sensor data exceeding one or more thresholds, and by causing a constant dim up or down of the brightness level of the lighting fixture to alert a user of an emergency condition.
